(19) United States
(12) Patent Application Publication
(10) Pub. No.: US 2014/0079935 A1
(43) Pub. Date: Mar. 20, 2014

(54) Flexible Thermoplastic Films And Articles

(71) Applicant: THE PROCTER & GAMBLE COMPANY, Cincinnati, OH (US)

(72) Inventor: Norman Scott Broyles, West Chester, OH (US)

(73) Assignee: THE PROCTER & GAMBLE COMPANY, Cincinnati, OH (US)

(21) Appl. No.: 13/835,300

(22) Filed: Mar. 15, 2013

Related U.S. Application Data
(60) Provisional application No. 61/703,508, filed on Sep. 20, 2012.

(51) Int. Cl. C08L 23/08; C08L 23/06

(52) U.S. Cl. CPC C08L 23/0869; C08L 23/06; C08L 23/0853
USPC 428/220; 524/50; 524/51; 524/52; 524/53

(57) ABSTRACT

A biodegradable, polyolefin-based material composition having incorporated therein thermoplastic starch particles is described. The material includes from about 5% to about 45% of a thermoplastic starch (TPS), from about 55% to about 95% of a polyolefin or mixtures of polyolefins, at least 9% of a compatibilizer and has a bio-based content of 5%-97% using ASTM D6866-10, method B.

### FIELD OF THE INVENTION

The present specification generally relates to a composition for flexible polyolefin-based films that contain thermoplastic starches having a bio-based content of about 5% to about 97% using ASTM D6866-10, method B. In particular, the invention pertains to product and packaging films that include petro- and bio-based polyolefins, renewable polymers, and a compatibilizer, and describes a method to overcome their material incompatibility to make product and packaging films of desirable physical and mechanical properties.

### BACKGROUND OF THE INVENTION

In recent years as petroleum resources become more scarce or expensive and manufacturers and consumers alike have become more aware of the need for environmental sustainability, interest in bio-degradable and renewable films containing renewable and or natural polymers for a variety of uses has grown. Renewable polymers available today, such as polylactic acid (PLA), polyhydroxyalkanoate (PHA), thermoplastic starch (TPS), etc., however, all have deficiencies in making thin, flexible product and packaging films that are typically used as packaging films for bath tissues, facial tissue, wet wipes and other consumer tissue products, product bags for personal care products, away-from-home products, and health care products and as components of disposable hygiene consumer products such as diapers and feminine hygiene articles. For instance, PLA thin film exhibits a high stiffness and very low ductility. Sometimes a costly bi-axial stretching process is used to produce thin PLA films, which results in relatively high rustling noise levels when handled and very brittle films, making the material unsuitable for flexible thin film packaging uses. PHA is difficult to make into thin films. Poor film processability (i.e., slow crystallization, extreme stickiness prior to solidification) retards fabrication-line speeds that result in relatively expensive production costs. Some PHA such as poly-3-hydroxybutyrate (PHB), poly-3-hydroxybutyrate-co-3-hydroxyvalerate (PHBV) films have high stiffness and low ductility, making them unsuitable for flexible thin film applications. TPS film has a low tensile strength, low ductility, and also severe moisture sensitivity. TPS also has difficulty to make thin films due to its low melt strength and extensibility making TPS not suitable for stand-alone packaging or product film applications unless used with expensive blends with compatible biodegradable polymers, such as Ecoflex™, an aliphatic-aromatic copolyester by BASF AG.

Common existing film equipment are optimal for converting polyethylene-based films. Efforts to replace or upgrade the film hardware to run 100% renewable polymers can require high capital expenditures. The poor processability of 100% renewable polymers also increases production cost due to reduced line speed, etc. Therefore, there is a need for thin packaging and product films containing renewable polymers and bio-based polyolefins to reduce the carbon foot print and improve environmental benefits at an affordable cost. The packaging and product films must have good performance required for packaging and product applications in terms of heat seal, tensile properties, no visible defects, and suitability for high speed packaging and product assembly applications.

### SUMMARY OF THE INVENTION

In one embodiment, the present invention addresses a need for a flexible polymeric film that is better or improved over conventional polyolefin films in terms of its environmental impact. The use of bio-based or renewable materials in films and utilizing natural or new carbon or recently fixed CO₂ by removing it from the atmosphere, can slightly reduce global warming effects. The production of the present inventive films can reduce energy input and green house gas emission. The relative degree of biodegradation is partial depending on the amount of biodegradable component present in the films, but it is more biodegradable than pure polyolefin thin films.

In general, the invention describes a flexible polymeric film having from about 5% to about 45% of a thermoplastic starch (TPS), from about 55% to about 95% of a petro-based or bio-based polyolefin or mixtures of petro-based and bio-based polyolefins, at least about 9% of a compatibilizer and has a bio-based content of 5%-97% using ASTM D6866-10, method B. The compatibilizer may have a non-polar backbone and a grafted polar functional monomer or a block copolymer of a both the non-polar block and a polar block. Alternatively, the compatibilizer may be a non-polymeric polar material or a non-polar material. The amounts of said thermoplastic starch and compatibilizer, respectively, can be present in a ratio of between about 3:1 to about 95:1. Typically, the ratio of said thermoplastic starch and compatibilizer, respectively, is between about 5:1 and about 55:1. More typically, the ratio of said thermoplastic starch and compatibilizer, respectively, is between about 7:1 and about 50:1.

The invention relates, in part, to a method of forming a polymeric film, the method comprising: preparing a petro-based and/or bio-based polyolefin mixture, blending said polyolefin mixture with a thermoplastic starch and a compatibilizer. The thermoplastic starch and the compatibilizer, respectively, are present in amounts in a ratio of between about 3:1 to about 95:1; extruding said film of said blended polyolefin mixture.

In another aspect the present invention pertains to a packaging material or assembly made from the polymeric film composition such as described. The film can be fabricated to be part of a packaging assembly. The packaging assembly can be used to wrap consumer products, such as absorbent articles including diapers, adult incontinence products, pantiliners, feminine hygiene pads, or tissues. In other iterations, the invention relates to a consumer product having a portion made using a flexible polymeric film, such as described. The polymeric film can be incorporated as part of consumer products, e.g., baffle films for adult and feminine care pads and liners, outer cover of diapers or training pants.

Additional features and advantages of the present invention will be revealed in the following detailed description. Both the foregoing summary and the following detailed description and examples are merely representative of the invention, and are intended to provide an overview for understanding the invention as claimed.

### DETAILED DESCRIPTION OF THE INVENTION

### I. Definitions

As used herein, the following terms shall have the meaning specified thereafter:

“Bio-based content” refers to the amount of carbon from a renewable resource in a material as a percent of the mass of the total organic carbon in the material, as determined by ASTM D6866-10, method B. Note that any carbon from inorganic sources such as calcium carbonate is not included in determining the bio-based content of the material.

“Bio-based polyolefin” refers to a polyolefin made from a renewable material obtained from one or more intermediate compounds (e.g., sugars, alcohols, organic acids). In turn, these intermediate compounds can be converted to olefin precursors.

“Biodegradable” refers generally to a material that can degrade from the action of naturally occurring microorganisms, such as bacteria, fungi, yeasts, and algae; environmental heat, moisture, or other environmental factors. If desired, the extent of biodegradability may be determined according to ASTM Test Method 5338.92.

“Compatibilizer” means an additive that, when added to a blend of immiscible polymers, modifies their interfaces and stabilizes the blend.

“Film” refers to a sheet-like material wherein the length and width of the material far exceed the thickness of the material.

“Monomeric compound” refers to an intermediate compound that may be polymerized to yield a polymer.

“Petro-based polyolefin” refers to a polyolefin derived from petroleum, natural gas, or coal via intermediate olefin precursors.

“Petrochemical” refers to an organic compound derived from petroleum, natural gas, or coal.

“Petroleum” refers to crude oil and its components of paraffinic, cycloparaffinic, and aromatic hydrocarbons. Crude oil may be obtained from tar sands, bitumen fields, and of l shale.

“Polymer” refers to a macromolecule comprising repeat units where the macromolecule has a molecular weight of at least 1000 Daltons. The polymer may be a homopolymer, copolymer, terpoymer etc. The polymer may be produced via free-radical, condensation, anionic, cationic, Ziegler-Natta, metallocene, or ring-opening mechanisms. The polymer may be linear, branched and/or cros slinked.

“Polyethylene” and “polypropylene” refer to polymers prepared from ethylene and propylene, respectively. The polymer may be a homopolymer, or may contain up to about 10 mol % of repeat units from a co-monomer.

“Renewable” refers to a material that can be produced or is derivable from a natural source which is periodically (e.g., annually or perennially) replenished through the actions of plants of terrestrial, aquatic or oceanic ecosystems (e.g., agricultural crops, edible and non-edible grasses, forest products, seaweed, or algae), or microorganisms (e.g., bacteria, fungi, or yeast).

“Renewable resource” refers to a natural resource that can be replenished within a 100 year time frame. The resource may be replenished naturally, or via agricultural techniques. Renewable resources include plants, animals, fish, bacteria, fungi, and forestry products. They may be naturally occurring, hybrids, or genetically engineered organisms. Natural resources such as crude oil, coal, and peat which take longer than 100 years to form are not considered to be renewable resources.

II. Polymers Derived from Renewable Resources

A number of renewable resources contain polymers that are suitable for use in polyolefin films (i.e., the polymer is obtained from the renewable resource without intermediates). Suitable extraction and/or purification steps may be necessary, but no intermediate compound is required. Such polymers derived directly from renewable resources include cellulose (e.g. pulp fibers), starch, chitin, polypeptides, poly(lactic acid), polyhydroxyalkanoates, and the like. These polymers may be subsequently chemically modified to improve end use characteristics (e.g., conversion of cellulose to yield carboxycellulose or conversion of chitin to yield chitosan). However, in such cases, the resulting polymer is a structural analog of the starting polymer.

Synthetic polymers of the present disclosure can be derived from a renewable resource via an indirect route involving one or more intermediate compounds. Suitable intermediate compounds derived from renewable resources include sugars. Suitable sugars include monosaccharides, disaccharides, trisaccharides, and oligosaccharides. Sugars such as sucrose, glucose, fructose, maltose may be readily produced from renewable resources such as sugar cane and sugar beets. Sugars may also be derived (e.g., via enzymatic cleavage) from other agricultural products such as starch or cellulose. For example, glucose may be prepared on a commercial scale by enzymatic hydrolysis of corn starch. While corn is a renewable resource in North America, other common agricultural crops may be used as the base starch for conversion into glucose. Wheat, buckwheat, arracaha, potato, barley, kudzu, cassava, sorghum, sweet potato, yam, arrowroot, sago, and other like starchy fruit, seeds, or tubers are may also be used in the preparation of glucose.

Other suitable intermediate compounds derived from renewable resources include monofunctional alcohols such as methanol or ethanol and polyfunctional alcohols such as glycerol. Ethanol may be derived from many of the same renewable resources as glucose. For example, cornstarch may be enzymatically hydrolyzed to yield glucose and/or other sugars. The resultant sugars can be converted into ethanol by fermentation. As with glucose production, corn is an ideal renewable resource in North America; however, other crops may be substituted. Methanol may be produced from fermentation of biomass. Glycerol is commonly derived via hydrolysis of triglycerides present in natural fats or oils, which may be obtained from renewable resources such as animals or plants.

Other intermediate compounds derived from renewable resources include organic acids (e.g., citric acid, lactic acid, alginic acid, amino acids etc.), aldehydes (e.g., acetaldehyde), and esters (e.g., cetyl palmitate, methyl stearate, methyl oleate, etc.).

Additional intermediate compounds such as methane and carbon monoxide may also be derived from renewable resources by fermentation and/or oxidation processes.

Intermediate compounds derived from renewable resources may be converted into polymers (e.g., glycerol to polyglycerol) or they may be converted into other intermediate compounds in a reaction pathway which ultimately leads to a polymer useful in a polyolefin film. An intermediate compound may be capable of producing more than one secondary intermediate compound. Similarly, a specific intermediate compound may be derived from a number of different precursors, depending upon the reaction pathways utilized.

Particularly desirable intermediates include olefins. Olefins such as ethylene and propylene may also be derived from renewable resources. For example, methanol derived from fermentation of biomass may be converted to ethylene and or propylene, which are both suitable monomeric compounds, as described in U.S. Pat. Nos. 4,296,266 and 4,083,889. Ethanol derived from fermentation of a renewable resource may be converted into the monomeric compound ethylene via dehydration as described in U.S. Pat. No. 4,423,270. Similarly, propanol or isopropanol derived from a renewable resource can be dehydrated to yield the monomeric compound of propylene as exemplified in U.S. Pat. No. 5,475,183. Propanol is a major constituent of fusel oil, a by-product formed from certain amino acids when potatoes or grains are fermented to produce ethanol.

Charcoal derived from biomass can be used to create syngas (i.e., CO+H₂) from which hydrocarbons such as ethane and propane can be prepared (Fischer-Tropsch Process). Ethane and propane can be dehydrogenated to yield the monomeric compounds of ethylene and propylene.

Other sources of materials to form polymers derived from renewable resources include post-consumer recycled materials. Sources of synthetic post-consumer recycled materials can include plastic bottles, e.g., soda bottles, plastic films, plastic packaging materials, plastic bags and other similar materials which contain synthetic materials which can be recovered.

### III. Exemplary Synthetic Polymers

Olefins derived from renewable resources may be polymerized to yield polyolefins. Ethylene and propylene derived from renewable resources may be polymerized under the appropriate conditions to prepare polyethylene and/or polypropylene having desired characteristics for use in polyolefin films. The polyethylene and/or polypropylene may be high density, medium density, low density, or linear-low density. Further, polypropylene can include homo-PP.

Polyethylene and/or polypropylene may be produced via free-radical polymerization techniques, or by using Ziegler-Natta (ZN) catalysis or Metallocene catalysts. Examples of such bio-sourced polyethylenes and polypropylenes are described in U.S. Publication Nos. 2010/0069691, 2010/0069589, 2009/0326293, and 2008/0312485; PCT Application Nos. WO2010063947 and WO2009098267; and European Patent No. 1102569. Other olefins that can be derived from renewable resources include butadiene and isoprene. Examples of such olefins are described in U.S. Publication Nos. 2010/0216958 and 2010/0036173.

Such polyolefins being derived from renewable resources can also be reacted to form various copolymers, including for example random block copolymers, such as ethylene-propylene random block copolymers (e.g., Borpact™ BC918CF manufactured by Borealis). Such copolymers and methods of forming same are contemplated and described for example in European Patent No. 2121318.

In addition, the polyolefin derived from a renewable resource may be processed according to methods known in the art into a form suitable for the end use of the polymer. The polyolefin may comprise mixtures or blends with other polymers such as polyolefins derived from petrochemicals.

It should be recognized that any of the aforementioned synthetic polymers (e.g., copolymers) may be formed by using a combination of monomers derived from renewable resources and monomers derived from non-renewable (e.g., petroleum) resources. For example, the copolymer can comprise propylene repeat units derived from a renewable resource and isobutylene repeat units derived from a petroleum source.

IV. Validation of Polymers Derived from Renewable Resources

A suitable validation technique is through ¹⁴C analysis. A small amount of the carbon dioxide in the atmosphere is radioactive. This ¹⁴C carbon dioxide is created when nitrogen is struck by an ultra-violet light produced neutron, causing the nitrogen to lose a proton and form carbon of molecular weight 14 which is immediately oxidized to carbon dioxide. This radioactive isotope represents a small but measurable fraction of atmospheric carbon. Atmospheric carbon dioxide is cycled by green plants to make organic molecules during photosynthesis. The cycle is completed when the green plants or other forms of life metabolize the organic molecules, thereby producing carbon dioxide which is released back to the atmosphere. Virtually all forms of life on Earth depend on this green plant production of organic molecules to grow and reproduce. Therefore, the ¹⁴C that exists in the atmosphere becomes part of all life forms, and their biological products. In contrast, fossil fuel based carbon does not have the signature radiocarbon ratio of atmospheric carbon dioxide.

Assessment of the renewably based carbon in a material can be performed through standard test methods. Using radiocarbon and isotope ratio mass spectrometry analysis, the bio-based content of materials can be determined. ASTM International, formally known as the American Society for

Testing and Materials, has established a standard method for assessing the bio-based content of materials. The ASTM method is designated ASTM D6866-10.

The application of ASTM D6866-10 to derive a “bio-based content” is built on the same concepts as radiocarbon dating, but without use of the age equations. The analysis is performed by deriving a ratio of the amount of organic radiocarbon (¹⁴C) in an unknown sample to that of a modern reference standard. The ratio is reported as a percentage with the units “pMC” (percent modern carbon).

The modern reference standard used in radiocarbon dating is a NIST (National Institute of Standards and Technology) standard with a known radiocarbon content equivalent approximately to the year AD 1950. AD 1950 was chosen since it represented a time prior to thermo-nuclear weapons testing which introduced large amounts of excess radiocarbon into the atmosphere with each explosion (termed “bomb carbon”). The AD 1950 reference represents 100 pMC.

“Bomb carbon” in the atmosphere reached almost twice normal levels in 1963 at the peak of testing and prior to the treaty halting the testing. Its distribution within the atmosphere has been approximated since its appearance, showing values that are greater than 100 pMC for plants and animals living since AD 1950. It's gradually decreased over time with today's value being near 107.5 pMC. This means that a fresh biomass material such as corn could give a radiocarbon signature near 107.5 pMC.

Combining fossil carbon with present day carbon into a material will result in a dilution of the present day pMC content. By presuming 107.5 pMC represents present day biomass materials and 0 pMC represents petroleum derivatives, the measured pMC value for that material will reflect the proportions of the two component types. A material derived 100% from present day soybeans would give a radiocarbon signature near 107.5 pMC. If that material was diluted with 50% petroleum derivatives, for example, it would give a radiocarbon signature near 54 pMC (assuming the petroleum derivatives have the same percentage of carbon as the soybeans).

A biomass content result is derived by assigning 100% equal to 107.5 pMC and 0% equal to 0 pMC. In this regard, a sample measuring 99 pMC will give an equivalent bio-based content value of 92%.

Assessment of the materials described herein was done in accordance with ASTM D6866. The mean values quoted in this report encompasses an absolute range of 6% (plus and minus 3% on either side of the bio-based content value) to account for variations in end-component radiocarbon signatures. It is presumed that all materials are present day or fossil in origin and that the desired result is the amount of bio-based component “present” in the material, not the amount of bio-based material “used” in the manufacturing process.

In one embodiment, a polyolefin film comprises a bio-based content value from about 5% to about 90% using ASTM D6866-10, method B. In another embodiment, a polyolefin film comprises a bio-based content value from about 20% to about 90% using ASTM D6866-10, method B. In yet another embodiment, a polyolefin film comprises a bio-based content value from about 50% to about 90% using ASTM D6866-10, method B.

In order to apply the methodology of ASTM D6866-10 to determine the bio-based content of a polyolefin film, a representative sample of the component must be obtained for testing. In one embodiment, a representative portion of the polyolefin film can be ground into particulates less than about 20 mesh using known grinding methods (e.g., Wiley® mill), and a representative sample of suitable mass taken from the randomly mixed particles.

The present invention enables manufacturers to make use of a majority of polyolefin compounds to achieve good processing characteristics and mechanical properties at low cost. The present invention describes a composition for and method of making thin packaging and product films for consumer packaged goods with suitable performance, renewable polymer and bio-based polyolefin content to reduce their environmental footprint, and at an attractive cost. The composition incorporates renewable polymers such as thermoplastic starch and, alternatively bio-based polyolefins, as renewable components. The amount of renewable polymers has to be at a volumetric minority so the polyolefins properties will dominate the blend properties. An appropriate type of additive at the right amount must be employed to compatibilize the two phases to create an adequate dispersion and good film properties.

It was surprisingly found that a range of intermediate compatibilizer additive compositions allow the blends to be compatibilized and have good physical and mechanical properties. An unexpected region of tertiary composition was found to permit films to form with good mechanical properties and good processability, and for the resultant films to be free from any visible defects. Outside of the compositions, gelled phases of either TPS or compatibilizer formed resulting in poor film mechanical properties and visual defects, thus making the films unsuitable for packaging and product applications. With too little compatibilizer, the renewable polymers (TPS) exist as un-dispersed gels leading to granular defects and visible voids/holes unsuitable for thin packaging or product film applications; at higher than optimal compatibilizer levels, the compatibilizer formed its own gelled phase and resulted in film defects. The other aspect of this invention is that the film material can be processed relatively easily and achieves good tensile strength and cohesive properties that allow packaging and product films to be produced at no productivity penalty or slow down in the converting process. Also disclosed in this invention are multiple-layered co-extruded flexible packaging or product films with one or more layer of the above films and one or more layer of a bio-based and/or petro-based polyolefin, such as polyethylene or mixed polyolefin layers. The presence of a polyolefin layer provides excellent sealability, printability, and mechanical properties required for either packaging or inclusion in consumer packaged goods.

The thermoplastic starch in the polymeric film comprises either a native starch or a modified starch with a plasticizer. The native starch can be selected from corn, wheat, potato, rice, tapioca, cassava, etc. The modified starch can be a starch ester, starch ether, oxidized starch, hydrolyzed starch, hydroxyalkylated starch, etc. Genetically modified starch can also be used; such modified starch may have a different ratio of amylose to amylopectin from that of amylose and amylopectin. Mixtures of two or more different types or modifications can also be used in this invention. The thermoplastic starch and the bio-based and/or petro-based polyolefin do not chemically bond with each other.

The thermoplastic starch composition may include one or more starches and a plasticizer or mixture of two or more plasticizers selected from polyhydric alcohols including glycerol, glycerine, ethylene glycol, polyethylene glycol, sorbitol, citric acid and citrate, or aminoethanol. In certain embodiments, the concentration of starch in the thermoplastic starch composition may be from about 45 wt. % or 50 wt. % to about 85 wt. % or 90 wt. %. One may include proportionate amounts of mixed starches of different origins or types (e.g., starches selected from corn, wheat, potato, rice, tapioca, cassava, etc.). According to certain other embodiments, the amount of starch and plasticizer present may include from about 60 or 65 wt. % to about 70 or 75 wt. % of starch, and from about 10 or 15 wt. % to about 30 or 40 wt. % plasticizers, inclusive of any combination of ranges there between. The plasticizers are commonly sourced from renewable materials and have a bio-based content of 100%.

High starch content plastics are highly hydrophilic and readily disintegrate on contact with water. This can be overcome through derivatization, as the starch has free hydroxyl groups which readily undergo a number of reactions such as acetylation, esterification and etherification, etc.

The resulting flexible film includes about 5% to about 45% of a renewable polymer such as thermoplastic starch (TPS), from 55% to 95% of a polyolefin or mixtures of polyolefins, either bio- or petro-based or mixtures thereof, and at least 9% of a compatibilizer, either bio- or petro-based or mixtures thereof. The compatibilizer may have a non-polar backbone and a grafted polar functional monomer or a block copolymer of a both a non-polar block and a polar block. Alternatively, the compatibilizer may be a non-polymeric polar material or a non-polar material. In another embodiment, the flexible film of the present invention comprises from 9% to 20% of a compatibilizer, either bio- or petro-based or mixtures thereof. In another embodiment, the flexible film of the present invention comprises from 10% to 15% of a compatibilizer, either bio- or petro-based or mixtures thereof. In another embodiment, the flexible film of the present invention comprises from 11% to 15% of a compatibilizer, either bio- or petro-based or mixtures thereof. In another embodiment, the flexible film of the present invention comprises from 9% to 14% of a compatibilizer, either bio- or petro-based or mixtures thereof.

According to alternate embodiments, the flexible polymeric film may incorporate as part of a master batch from about 5% to about 45% of a thermoplastic starch concentrate, from about 40% to 55% of a polyolefin, either bio- or petro-based or mixtures thereof, and from about 1% to about 15% of a color concentrate. The color concentrate can be added to make the otherwise clear film opaque or white. The colorant may include, for instance, various dyes, titanium oxide, calcium carbonate, or opacifiers such as clays, etc. Thermoplastic starch concentrate can have from about 50% to about 90% by weight starch, from about 5 to about 40% a polyolefin, either bio- or petro-based or mixtures thereof, and from about 9 to about 20% a compatibilizer, either bio- or petro-based or mixtures thereof.

Examples of the polyolefins that may be incorporated include low-density polyethylene such as ExxonMobil LD-129.85, high-density polyethylene such as Alathon M6020 from Equistar and Braskem SGM 9450F, linear low-density polyethylene such as Dow Dowlex 2045G and Braskem Braskem SLH 118, polyolefin elastomers such as Vistmaxx 3020FL from Exxon Mobil, or ethylene copolymers with vinyl acetate, or methacrylate, etc. The compatibilizer may include: ethylene vinyl acetate (EVA), ethylene vinyl alcohol (EVOH), ethylene-co-acrylic acid polymer, and a graft copolymer of non-polar polymer grafted with a polar monomer such as a polyethylene grafted with maleic anhydride. The polar functional monomer is maleic anhydride, acrylic acid, vinyl acetate, vinyl alcohol or acrylate. The polar functional monomer may be present in an amount that ranges from about 0.1% or 0.3% to about 40% or 45% by weight; desirably, about 0.5 wt. % or 1 wt. % to about 35 wt. % or 37 wt. %, inclusive. Mixed polyethylenes or polyethylene/polypropylene blends, both bio- and petro-based and mixtures thereof can also be used in this invention. The composition may also contain from about 0.5% to about 30% of a biodegradable polymer and may have a bio-based content of 5% to 90%.

The polymeric film can include a mineral filler that is present in an amount from about 5% or 8% to about 33% or 35% by weight, inclusive. Typically, the mineral filler is present in an amount from about 10% or 12% to about 25% or 30% by weight. The mineral filler may be selected from any one or a combination of the following: talcum powder, calcium carbonate, magnesium carbonate, clay, silica, alumina, boron oxide, titanium oxide, cerium oxide, germanium oxide, etc.

The polymeric packaging and product films can have multiple layers, for instance, from 1 to 7 or 8 layers; or in some embodiments, between about 2 or 3 to about 10 layers. The combined polymeric film layers can have a thickness of ranging from about 0.5 mil to about 5 mil, typically from about 0.7 or 1 mil to about 3 or 4 mil. Each layer can have a different composition, but at least one of the layers is formed from the present film composition. The at least one layer is formed with a thermoplastic starch concentrate such as a blend of thermoplastic starch, polyethylene, either bio- or petro-based or mixtures thereof, and a compatibilizer with the high thermoplastic starch content, in some cases the starch content of the TPS can range from 50 to 90% by weight. The polyethylene in the layer can be low density polyethylene, linear low density polyethylene, high density polyethylene or ethylene copolymers, or mixtures of polyolefins. At least one layer on the seal side is polyethylene layer. Alternatively, a polymeric flexible film layer has a thickness from about 10 or 15 micrometers to about 90 or 100 micrometers. Typically, the film has a thickness from about 15 or 20 micrometer to about 45 or 50 micrometers. Desirably, the film thickness is about 15 to about 35 micrometers.

Generally, the flexible polymeric film according to the invention exhibits a modulus from about 50 MPa to about 500 Mpa, and the peak stress ranges from about 15 MPa to about 50 MPa, at an elongation of from about 200% to about 1000% of the original dimensions. Typically, the modulus is in a range from about 55 or 60 MPa to about 260 or 275 MPa, and more typically from about 67 or 75 MPa to about 225 or 240 MPa, inclusive of any combination of ranges there between. Typically, the peak stress can range from about 20 or 23 MPa to about 40 or 45 MPa, inclusive of any combination of ranges there between.

The polymeric film will tend to have a micro-textured surface with topographic features, such as ridges or bumps, of between about 0.5 or 1 micrometers up to about 10 or 12 micrometers in size. Typically the features will have a dimension of about 2 or 3 micrometers to about 7 or 8 micrometers, or on average about 4, 5, or 6 micrometers. The particular size of the topographic features will tend to depend on the size of the individual starch particles, and/or their agglomerations.

The present invention can be used to create flexible polyolefin-based films based on polyethylene and TPS (preformed), and a plasticizer, which are more suited to the specific requirements of packaging films.

In another aspect, the invention describes a method of forming a polymeric film. The method comprises: preparing a polyolefin mixture, either bio- or petro-based or mixtures thereof, blending said polyolefin mixture with a thermoplastic starch and a compatibilizer, either bio- or petro-based or mixtures thereof. The compatibilizer may have a non-polar backbone and a grafted polar functional monomer or a block copolymer of a both a non-polar block and a polar block. Alternatively, the compatibilizer may be a non-polymeric polar material or a non-polar material. Said thermoplastic starch and compatibilizer, respectively, are present in amounts in a ratio of between about 3:1 to about 95:1; extruding said film of said blended polyolefin mixture. Desirably, the compatibilizer is EAA (ethylene acrylic acid).

Alternatively, the method of forming a polymeric film may include the steps of preparing a polyolefin mixture, either bio- or petro-based or mixtures thereof; blending the polyolefin mixture with a thermoplastic starch concentrate; and extruding said mixture to form a film of said blended polyolefin mixture. The starch concentrate and polyolefins, respectively, are present in amounts in a ratio of between about 1:1 to about 0.1:1.

The following description and examples will further illustrate the present invention. It is understood that these specific embodiments are representative of the general inventive concept.

### A. Blends of Polyethylene and Thermoplastic Starch (TPS)

For purposes of illustration, thermoplastic starch samples are prepared with a twin-screw compounding extruder. As an example, cornstarch is incorporated at about 50 or 70 wt. % to about 85 or 90 wt. %, and a plasticizer, such as glycerol or sorbitol, is added up to about 30 or 33wt. %. A surfactant, such as Excel P-40S, is added to help lubricate the thermoplastic mixture. The mixture is extruded under heat and mechanical shear to form TPS. Blending the TPS with a Maleic Anhydride Modified Polyolefin (e.g. LLDPE, LDPE, HDPE, PP, etc.) polymer produces films with un-dispersed aggregates of TPS in the films. The TPS and polyolefin are observed to be not compatible with each other in either source of TPS. An explanation appears to be found in the molecular structure of each material. The starch is comprised of two components: Amylopectin, which exists as about 70-80% of corn starch's composition, is a highly branched component of starch. The remaining percentage (20-30%) of starch's composition is amylose, which is the mostly linear component of starch. Both amylopectin and amylose contain a large number of hydroxyl groups and the glucose derived units are connected by oxygen atoms (i.e. ether linkages). Plant starch from different plant types can have different ratio of amylose to amylopectin.

In contrast, the molecular structure of polyethylene is a simple saturated hydrocarbon. Polyethylene does not contain any polar functional groups such as hydroxyl groups, nor are they linked by oxygen atoms. The mixing of these two components was not fully homogenous because polyethylene does not contain any polar functional groups that will cause the starch to disperse evenly throughout the film material. The films created from thermoplastic starch and polyethylene alone exhibit many undispersed starch aggregates and holes due to their incompatibility.

### B. Compatibilizers

To improve the compatibility and dispersion characteristics of TPS in polyolefins, several compatibilizers with both polar and non-polar groups are incorporated in the present invention. The compatibilizers may include several different kinds of copolymers, for example, polyethylene-co-vinyl acetate (EVA), polyethylene-co-vinyl alcohol (EVOH), polyethylene-co-acrylic (EAA), and a graft copolymer of a polyolefin (e.g., polyethylene)(e.g., DuPont Fusabond™. MB-528D) and maleic anhydride based on molecular structure considerations. EVA, EVOH, EAA, etc. both have a non-polar polyethylene subunit in their backbone. The vinyl acetate subunit contains an ester group, which associate with the hydroxyls of the amylopectin and amylose. Instead of the ester group from the vinyl acetate, EVOH has a vinyl alcohol group which has hydroxyl group as in starch. Both the ester group in EVA and the hydroxyl group in EVOH do not chemically react with the hydroxyl groups in starch molecules. They only associate with starch through hydrogen bonding or polar-polar molecular interactions. Using these two physical compatibilizers, TPS and EVA or EVOH blends showed improved compatibility versus the un-compatibilized PE/TPS blends.

The compatibilizers can also be produced by grafting reactive functional monomers onto bio-based polymers such as biopolyethylene. Examples include the grafting of Maleic Anhydride or Acrylic acid onto Braskem SLH 118 to produce a comptibilizer with high level of bio-based content.

Fusabond™ MB-528D is a graft copolymer of polyethylene and maleic anhydride. In its structure, the cyclic anhydride at one end is chemically bonded directly into the polyethylene chain. The polar anhydride group of the molecule could associate with the hydroxyl groups in the starch via both hydrogen bonding and polar-polar molecular interactions and a chemical reaction to form an ester linkage during the melt extrusion process. The hydroxyls of the starch can undergo esterification reaction with the anhydride to achieve a ring-opening reaction to chemically link the TPS to the maleic anhydride that is grafted to polyethylene. This reaction is accomplished under the high temperatures and pressures of the extrusion process.

For example, the DuPont Fusabond™ MB-528D, at a concentration of about 1-5% completely dispersed the thermoplastic starch in the film. The EVA and EVOH worked sufficiently well to disperse the starch particles. In comparison to the graft copolymer of polyethylene and maleic anhydride, however, EVA and EVOH, even at higher percentages of around 10 or 15%, did not fully disperse the TPS in the film. Hence, the graft copolymer of polyethylene and maleic anhydride appears to be a more effective compatibilizer.

The compatibilizer may have a non-polar backbone and a grafted polar functional monomer or a block copolymer of a both a non-polar block and a polar block. Alternatively, the compatibilizer may be a non-polymeric polar material or a non-polar material. In another embodiment, the flexible film of the present invention comprises from 9% to 20% of a compatibilizer. In another embodiment, the flexible film of the present invention comprises from 10% to 15% of a compatibilizer. In another embodiment, the flexible film of the present invention comprises from 11% to 15% of a compatibilizer. In another embodiment, the flexible film of the present invention comprises from 9% to 14% of a compatibilizer.

According to the present invention, the amount of TPS and compatibilizer, respectively, present in the composition can be expressed as a ratio of between about 3:1 to about 95:1. Alternatively, the ratio may be, for instance, between about 5.5:1 or 6:1 to about 90:1 or 95:1, or any combination or permutation of ratio values there between. Alternatively, the ratio may be, for instance, between about 7:1 or 7.5:1 to about 60:1 or 70:1, or preferably between about 10:1 or 12:1 to about 50:1 or 55:1, or between about 20:1 or 22:1 to about 40:1 or 45:1 (e.g., 25:1, 27:1, 30:1, 33:1, or 35:1).

### C. Illustrative Consumer Product

The present thermoplastic film materials can be used to make packaging for various kinds of consumer products in general terms. For purpose of illustration, certain package embodiments may be for consumer products such as absorbent articles (e.g., baby diapers or feminine hygiene articles). The package can have one or more absorbent articles disposed therein. As used herein, the term “absorbent article” refers to devices that absorb and/or contain a substance, such as, e.g., body exudates. A typical absorbent article can be placed against or in proximity to the body of the wearer to absorb and contain various body excretions. As used herein, the term “feminine hygiene article” refers to articles such as, e.g., disposable absorbent articles that can be worn by women for menstrual and/or light incontinence control, such as, for example, sanitary napkins, tampons, interlabial products, incontinence articles, and liners. As used herein, the term “feminine hygiene article” can also refer to other articles for use in the pudendal region such as, e.g., wipes and/or powder. As used herein, a feminine hygiene article can include any associated wrapping or applicator that typically can be associated with the feminine hygiene article. For example, a feminine hygiene article can be a tampon that may or may not include an applicator and/or can be a sanitary napkin that may or may not include a wrapper, such as, e.g., a wrapper that individually encloses the sanitary napkin. Feminine hygiene articles do not include baby diapers.

### D. Examples

The following examples further describe and demonstrate the preferred embodiments within the scope of the present invention. The examples are given solely for the purpose of illustration and are not to be construed as limitations of the present invention since many variations thereof are possible without departing from the spirit and scope of the invention. Ingredients are identified by chemical name, or otherwise defined below.

### Example 1

A mixture of 22.5% edible starch w/degree of substitution >0.1 from Shandong Zhucheng Starch PTY, 5% glycerol (>96% purity), 2.7% sorbitol (>70% purity), 5.4% EAA (Dow Primacor 3340), 4.5% Attane 4404, 5.6% DuPont Fusabond E100, and 54.3% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 2

A mixture of 7.2% edible starch w/degree of substitution >0.1 from Shandong Zhucheng Starch PTY, 1.8% glycerol (>96% purity), 0.9% sorbitol (>70% purity), 1.8% EAA (Dow Primacor 3340), 1.5% Attane 4404, 10.2% DuPont Fusabond E100, and 76.6% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 3

A mixture of 22.5% edible starch w/degree of substitution >0.1 from Shandong Zhucheng Starch PTY, 5% glycerol (>96% purity), 2.7% sorbitol (>70% purity), 11.0% EAA (Dow Primacor 3340), 4.5% Attane 4404, and 54.3% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 4

A mixture of 7.2% edible starch w/degree of substitution >0.1 from Shandong Zhucheng Starch PTY, 1.8% glycerol (>96% purity), 0.9% sorbitol (>70% purity), 11.0% EAA (Dow Primacor 3340), 1.5% Attane 4404, and 77.6% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 5

A mixture of 45% Cardia BLF-02, 5.6% DuPont Fusabond E100, and 49.4% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 6

A mixture of 15.0% Cardia BLF-02, 9.2% DuPont Fusabond E100, and 75.8% Dowlex 2045G was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 7

A mixture of 45% Cardia BLF-02, 5.6% DuPont Fusabond E100, 44.4% Dowlex 2045G, and 5% Ampacet TiO2 masterbatch (50% Ti02) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 8

A mixture of 15.0% Cardia BLF-02, 9.2% DuPont Fusabond E100, 70.8% Dowlex 2045G, and 5% Ampacet TiO2 masterbatch (50% Ti02) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 9

A multilayer film with an overall mixture of 45% Cardia BLF-02, 5.6% DuPont Fusabond E100, 44.4% Dowlex 2045G, and 5% Ampacet TiO2 masterbatch (50% Ti02) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 10

A multilayer film with an overall mixture of 15.0% Cardia BLF-02, 9.2% DuPont Fusabond E100, 70.8% Dowlex 2045G, and 5% Ampacet TiO2 masterbatch (50% Ti02) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 11

A mixture of 22.5% edible starch w/degree of substitution >0.1 from Shandong Zhucheng Starch PTY, 5% glycerol (>96% purity), 2.7% sorbitol (>70% purity), 5.4% EAA (Dow Primacor 3340), 4.5% Attane 4404, 5.6% DuPont Fusabond E100, and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 12

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Braskem SLH 118 reactively extruded with petro sourced acrylic acid), 4.5% Attane 4404, 5.6% DuPont Fusabond E100, and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 13

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Braskem SLH 118 reactively extruded with biosourced acrylic acid), 4.5% Attane 4404, 5.6% DuPont Fusabond E100, and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 14

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Braskem SLH 118 reactively extruded with biosourced acrylic acid), 4.5% Attane 4404, 5.6% sourced from Braskem SLH 118 reactively extruded with biosourced maleic anhydride), and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 15

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Braskem SLH 118 reactively extruded with biosourced acrylic acid), 4.5% Attane 4404, 5.6% sourced from Braskem SLH 118 reactively extruded with biosourced maleic anhydride), and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 16

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Braskem SLH 118 reactively extruded with petrosourced acrylic acid), 4.5% Attane 4404, 5.6% sourced from Braskem SLH 118 reactively extruded with biosourced maleic anhydride), and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

### Example 17

A mixture of 22.5% edible starch w/degree of substitution >0.1 from Shandong Zhucheng Starch PTY, 5% glycerol (>96% purity), 2.7% sorbitol (>70% purity), 5.4% EAA (sourced from Dowlex 2045G reactively extruded with biosourced acrylic acid), 4.5% Attane 4404, 5.6% sourced from Braskem SLH 118 reactively extruded with biosourced maleic anhydride), and 54.3% Braskem SLH 118 (bioPE) was fed to a Collins blown film line with a 30 mm 30 L/D extruder and a 4″ die operating with a 2.5 blow up ratio. The die gap was 2.0 mm and the melt temperature was 180 Celsius. The blown film was 50 microns in thickness.

The present invention has been described in general and in detail by way of examples. Persons of skill in the art understand that the invention is not limited necessarily to the embodiments specifically disclosed, but that modifications and variations may be made without departing from the scope of the invention as defined by the following claims or their equivalents, including other equivalent components presently known, or to be developed, which may be used within the scope of the present invention. Therefore, unless changes otherwise depart from the scope of the invention, the changes should be construed as being included herein. All percentages are expressed in weight percentages.

What is claimed is:

1. A flexible polymeric film comprising: from about 5% to about 45% of a thermoplastic starch (TPS), from about 55% to about 95% of a polyolefin or mixtures of polyolefins, and at least 9% of a compatibilizer.

2. The polymeric film according to claim 1 having a bio-based content of 5%-97%.

3. The polymeric film according to claim 1 having a bio-based content of 20%-97%.

4. The polymeric film according to claim 1, wherein the amounts of said thermoplastic starch and compatibilizer, respectively, are present in a ratio of between about 5.5:1 to about 95:1.

5. The polymeric film according to claim 1, wherein the thermoplastic starch comprises a native starch or a modified starch with a plasticizer; wherein said native starch is selected from corn, wheat, potato, rice, tapioca, cassava; wherein said modified starch is a starch ester, starch ether, oxidized starch, hydrolyzed starch, hydroxyalkylated starch; and wherein said a plasticizer or mixture of two or more plasticizers selected from polyhydric alcohols including glycerol, glycerine, ethylene glycol, polyethylene glycol, sorbitol, citric acid and citrate, or aminoethanol.

6. The polymeric film according to claim 5, wherein the thermoplastic starch comprises from about 55 to 95% starch and from 5 to 45% plasticizers, and optionally 0.5 to 5% of surfactant.

7. The polymeric film according to claim 1, wherein said polyolefins include: low-density polyethylene, high-density polyethylene, linear low-density polyethylene, polyolefin elastomers, ethylene copolymers with vinyl acetate, or methacrylate.

8. The polymeric film according to claim 1, wherein said compatibilizer is selected from the group consisting of ethylene vinyl acetate copolymer (EVA), ethylene vinyl alcohol copolymer (EVOH), ethylene acrylic acid (EAA), a graft copolymer of polyethylene and maleic anhydride, and combinations thereof.

9. The polymeric film according to claim 1, wherein the amounts of said thermoplastic starch and compatibilizer, respectively, are present in a ratio of between about 7.5:1 and about 55:1.

10. The polymeric film according to claim 1, wherein the amounts of said thermoplastic starch and compatibilizer, respectively, are present in a ratio of between about 10:1 and about 50:1.

11. The polymeric film according to claim 1, comprising from 9% to about 20% of a compatibilizer.

12. The polymeric film according to claim 1, comprising from 9% to about 14% of a compatibilizer.

13. The polymeric film according to claim 1, comprising from 10% to about 15% of a compatibilizer.

14. The polymeric film according to claim 1, comprising from 11% to about 15% of a compatibilizer.

15. The polymeric film according to claim 1, wherein a mineral filler that includes: talcum, calcium carbonate, magnesium carbonate, clay, silica, alumina, boron oxide, titanium oxide, cerium oxide, or germanium oxide, is present in an amount from about 5% to about 35% by weight.

16. The polymeric film according to claim 1, wherein the said film has a thickness from about 10 micrometers to about 100 micrometers, desirably from about 15 micrometer to about 35 micrometers.

17. A packaging assembly for a consumer product, said packaging comprising at least a portion made from a polymeric film according to claim 1.

18. A consumer product comprising a portion made with a flexible polymeric film according to claim 1, wherein said consumer product is an absorbent article including diapers, pantiliners, feminine pads, adult incontinence products, wipers, or tissues.

19. A consumer product according to claim 18, wherein said polymeric film includes from about 5% to about 45% of a thermoplastic starch (TPS), from about 55% to about 95% of a polyolefin or mixtures of polyolefins, and at least 9% of a compatibilizer, the amounts of said thermoplastic starch and compatibilizer, respectively, are present in a ratio of between about 7.5:1 to about 95:1.
